(19) United States
(12) Patent Application Publication
(10) Pub. No.: US 2009/0189937 A1
(43) Pub. Date: Jul. 30, 2009

(54) IMAGE FORMING APPARATUS

(75) Inventors: Shinichiro Naruse, Kanagawa (JP); Kenichi Kawabata, Kanagawa (JP); Takayuki Niihara, Kanagawa (JP); Mamoru Yorimoto, Tokyo (JP); Tetsu Morino, Kanagawa (JP); Takumi Hagiwara, Aichi (JP)

Correspondence Address: COOPER & DUNHAM, LLP, 30 Rockefeller Plaza, 20th Floor, NEW YORK, NY, 10112, US

(73) Assignee: RICOH COMPANY, LTD, Tokyo (JP)

(21) Appl. No.: 12/359,450

(22) Filed: Jan. 26, 2009

(30) Foreign Application Priority Data
Jan. 28, 2008 (JP) 2008-016099

(51) Int. Cl. B41J 29/38

(52) U.S. Cl. 347/13

(57) ABSTRACT

A disclosed image forming apparatus includes a carriage on which a recording head is mounted that has a nozzle array where plural nozzles for ejecting droplets are arranged, the carriage being configured to be moved in a direction orthogonal to a nozzle arrangement direction; a transport belt facing the recording head and configured to transport a sheet; a print pattern forming unit configured to form a print pattern on the transport belt by causing at least the nozzles at opposing ends of the nozzle array to eject the droplets onto the transport belt while stopping the carriage; a reading unit configured to read the print pattern; a measuring unit configured to measure print positions of plural points of the print pattern in a direction orthogonal to the nozzle arrangement direction; and a detecting unit configured to detect an inclination of the recording head.

### BACKGROUND OF THE INVENTION

1. Field of the Invention

The present invention relates to an image forming apparatus including a recording head that ejects droplets.

2. Description of the Related Art

There are image forming apparatuses such as printers, facsimile machines, copying machines, plotters, and multifunction machines having functions of these devices. Inkjet recording apparatuses are known as liquid ejection recording type image forming apparatuses that use a recording head for ejecting ink droplets. The liquid ejection recording type image forming apparatuses form an image on a sheet by ejecting ink droplets from a recording head onto a sheet being transported. The image forming apparatuses of this type include serial type image forming apparatuses that form an image by ejecting droplets from a recording head moving in a main scanning direction and line type image forming apparatuses that form an image by ejecting droplets from a stationary recording head. The term “sheet” as used herein is not limited to paper but may be any substance, including OHP sheets, to which ink droplets or liquid can adhere. The “sheet” may also be referred to as a “to-be-recorded medium”, a “recording medium”, “recording paper”, and a “recording sheet”. The term “recording”, “printing”, and “imaging” may be used as synonyms for the term “image formation”.

The term “image forming apparatus” as used herein indicates an apparatus that forms images by ejecting liquid onto media such as paper, strings, fibers, cloth, leather, metal, plastic, glass, wood, and ceramics. The term “image formation” as used herein indicates not only forming images that have meanings, such as characters and figures, on a medium, but also forming images that do not have meanings, such as patterns, on a medium (i.e., merely ejecting droplets onto a medium). The term “ink” as used herein indicates not only those commonly called ink but is also used as a general term for all the types of liquids that can form images, such as recording liquid, fixing solution, and those called liquid.

The liquid ejection recording type image forming apparatuses need to eject droplets onto target positions with high accuracy in order to form an image by superposition of the droplets. However, even if the recording head is positioned with high accuracy at the time of manufacture, the head position may be changed with time or may be changed when replacing the recording head due to malfunction or the like. If the installed state (mounted state) of the recording head is changed as described above, a droplet impact position shift may occur, resulting in reduced image quality.

There have been techniques for correcting impact position shifts. For example, Japanese Patent Laid-Open Publication No. 2004-314361 (Patent Document 1) discloses a liquid injection device including a recording head with an image detector capable of optically reading a test pattern, which is formed on recording paper by ejection of ink droplets. The liquid injection device acquires gap information indicating a platen gap from a nozzle opening to the recording paper surface based on a detection signal from a gap detector. The liquid injection device also acquires position correction information for each platen gap based on the information read by the image detector, and stores the acquired position correction information in a correction information memory element. Then, the liquid injection device acquires the position correction information based on the gap information and adjusts the ink droplet ejection timing according to the acquired position correction information.

Japanese Patent Laid-Open Publication No. 2005-31144 (Patent Document 2) discloses a droplet ejection device including a gap adjuster. The gap adjuster includes a position measuring unit for measuring plural vertical positions of a nozzle face, a gap measuring system moving mechanism for moving a droplet ejection head with respect to the position measuring unit, a lifting unit for vertically moving the droplet ejection head with respect to a workpiece to adjust the gap from the workpiece, and a control unit for controlling the lifting unit based on the measurement results of the measuring unit. The control unit controls the lifting unit so that the space between the surface of the workpiece and the measured position nearest to the workpiece, which is selected based on the measurement results of the measuring unit, has a predetermined distance.

Japanese Patent Laid-Open Publication No. 2006-264074 (Patent Document 3) discloses a droplet ejection device including a gap sensor on a part (different from a part where a head unit is disposed) of a transport belt for detecting a gap between the head unit and the transport belt. The droplet ejection device corrects the timing of ejecting droplets from a nozzle of a recording head based on possible irregularities of the transport belt or recording sheets.

Japanese Patent Laid-Open Publication No. 2003-62985 (Patent Document 4) discloses an inkjet printer that measures a nozzle position shift amount for each speed profile for driving a carriage in advance, stores the measured nozzle position shift amount in a data table, reads out the nozzle position shift amount in a carriage position of the print timing from the data table upon performing printing, calculates a print timing shift based on the read nozzle position shift amount and the carriage speed in each ink ejection position, and corrects the print timing.

As a technique for performing various detections using an optical sensor, Japanese Patent Laid-Open Publication No. 2006-178396 discloses a deposition amount conversion method. This method uses an optical detecting unit that is disposed in a position opposing a detection target surface and is capable of detecting specular reflection light and diffused reflection light. The optical detecting unit detects the detection target surface and plural gradation patterns of different deposition amounts that are continuously formed on the detection target surface and obtains a specular reflection light output voltage and a diffused reflection light output voltage of the gradation patterns. A diffused reflection light output conversion value is calculated by subtracting a value, which is obtained by multiplying a relative output ratio of a specular reflection light component, extracted from the specular reflection light output, to a specular reflection component of the background by a diffused reflection light output voltage of the detection target surface and an increase in the diffused reflection output voltage corresponding to the difference from a diffused light output value of the optical detecting unit when a light emitting unit is turned off, from the diffused reflection light output voltage and the increase in the diffused reflection light output voltage. Then, the diffused reflection light output conversion value is approximated using a polynomial approximation technique in relationship with the deposition amount in a medium deposition region.

However, the devices disclosed in Patent Documents 1-4 cannot detect a change in the recording head attachment position and hence cannot determine whether the impact position shift is caused due to a change in the recording head attachment position.

The device of Patent Document 2 needs to have the optical position measuring unit (sensor) at the side opposing the nozzle face and hence cannot measure a gap with the surface to be printed. Moreover, measurement from the vertically downward position using the laser beam sensor may not provide accurate measurement due to ink mist or the like. The device of Patent Document 3 needs to have many sensors in the upstream side in the sheet transport direction in order to detect gap deviation in a broad area in the main scanning direction, which results in high costs. Moreover, the device does not measure a gap in the head position and hence fluctuation of the gap may occur while moving the carriage.

The device of Patent Document 4 needs to measure and record the speed profile for each carriage driving speed. Moreover, the device requires sophisticated electric hardware (e.g., processors and memories) to read the nozzle position shift amount from the data table and perform correction for all the pieces of print data, which results in high costs.

### SUMMARY OF THE INVENTION

The present invention is directed toward accurately detecting an inclination of a recording head and preventing a reduction in the image quality.

According to an aspect of the present invention, there is provided an image forming apparatus that includes a carriage on which a recording head is mounted that has a nozzle array where plural nozzles for ejecting droplets are arranged, the carriage being configured to be moved in a direction orthogonal to a nozzle arrangement direction; a transport belt facing the recording head and configured to transport a sheet; a print pattern forming unit configured to form a print pattern on the transport belt by causing at least the nozzles at opposing ends of the nozzle array of the recording head to eject the droplets onto the transport belt while stopping the carriage; a reading unit configured to read the print pattern formed on the transport belt; a measuring unit configured to measure print positions of plural points of the print pattern, which are located at different positions in the nozzle arrangement direction, in a direction orthogonal to the nozzle arrangement direction based on a read result of the reading unit; and a detecting unit configured to detect an inclination of the recording head based on a measurement result of the print positions.

The above-described image forming apparatus forms a print pattern on the transport belt by ejecting droplets from at least nozzles at the opposing ends of the nozzle array of the recording head while the carriage is stopped, measures the print positions of the plural points of the print pattern, which are located at different positions in the nozzle arrangement direction, in the direction orthogonal to the nozzle arrangement direction based on the read results of the reading unit which reads the print pattern on the transport belt, and detects the inclination of the recording head based on the measurement results of the print positions. Therefore, it is possible to accurately detect an inclination of the recording head and prevent a reduction in the image quality by, for example, correcting an impact position shift.

According to another aspect of the present invention, there is provided an image forming apparatus that includes a line type recording head having a nozzle array where plural nozzles for ejecting droplets are arranged across a sheet width; a transport belt facing the recording head and configured to transport a sheet; a print pattern forming unit configured to form a print pattern by causing at least the nozzles at opposing ends of the nozzle array of the recording head to eject the droplets onto the transport belt; a reading unit configured to read the print pattern formed on the transport belt; a measuring unit configured to measure print positions of plural points of the print pattern, which are located at different positions in the nozzle arrangement direction, in a direction orthogonal to the nozzle arrangement direction based on a read result of the reading unit; and a detecting unit configured to detect an inclination of the recording head based on a measurement result of the print positions.

The above-described image forming apparatus forms a print pattern on the transport belt by ejecting droplets from at least nozzles at the opposing ends of the nozzle array of the line type recording head, measures the print positions of the plural points of the print pattern, which are located at different positions in the nozzle arrangement direction, in the direction orthogonal to the nozzle arrangement direction based on the read results of the reading unit which reads the print pattern on the transport belt, and detects the inclination of the recording head based on the measurement results of the print positions. Therefore, it is possible to accurately detect an inclination of the recording head and prevent a reduction in the image quality by, for example, correcting an impact position shift.

### BRIEF DESCRIPTION OF THE DRAWINGS

Other objects, features and advantages of the present invention will become more apparent from the following detailed description when read in conjunction with the accompanying drawings, in which:

FIG. 1 is a schematic configuration diagram illustrating an example of an image forming apparatus according to an embodiment of the present invention;

FIG. 2 is a plan view illustrating an image forming unit and a sub scanning transport unit of the image forming apparatus;

FIG. 3 is a partly cut-away front view illustrating the image forming unit and the sub scanning transport unit;

FIG. 4 is a diagram for explaining a recording head;

FIG. 5 is a block diagram illustrating a control unit of the image forming apparatus of FIG. 1;

FIG. 6 is a functional block diagram illustrating components of the image forming apparatus for head inclination detection and droplet impact position correction;

FIG. 7 is a diagram for explaining the components of the image forming apparatus for head inclination detection and droplet impact position correction;

FIG. 8 is a diagram for explaining formation of a print pattern on a transport belt and the principle of detection of the print pattern;

FIG. 9 is a diagram for explaining a pattern of a comparative example;

FIG. 10 is a diagram showing diffusion of light by a droplet for explaining the principle of pattern detection;

FIG. 11 is a diagram showing diffusion of light by a flat droplet;

FIG. 12 is a graph showing a relationship between the time elapsed from the impact of a droplet and the sensor output voltage;

FIG. 13 is a diagram for explaining formation and reading of a print pattern used for detection of a recording head inclination according to an embodiment of the present invention;

FIG. 14 is a schematic diagram for explaining formation of the print pattern;

FIGS. 15A-15D are diagrams for explaining an operation for forming the print pattern;

FIGS. 16A and 16B are diagrams for explaining an operation for reading the print pattern;

FIG. 17 is a perspective view illustrating another example of a reading sensor arrangement;

FIG. 18 is a flowchart for explaining a first example of a process for head inclination detection by a control unit;

FIG. 19 is a flowchart for explaining a second example of a process for head inclination detection;

FIG. 20 is a flowchart for explaining a third example of a process for head inclination detection;

FIG. 21 is a flowchart for explaining a fourth example of a process for head inclination detection; and

FIG. 22 is a plan view for explaining another embodiment of the present invention.

### DETAILED DESCRIPTION OF THE PREFERRED EMBODIMENT

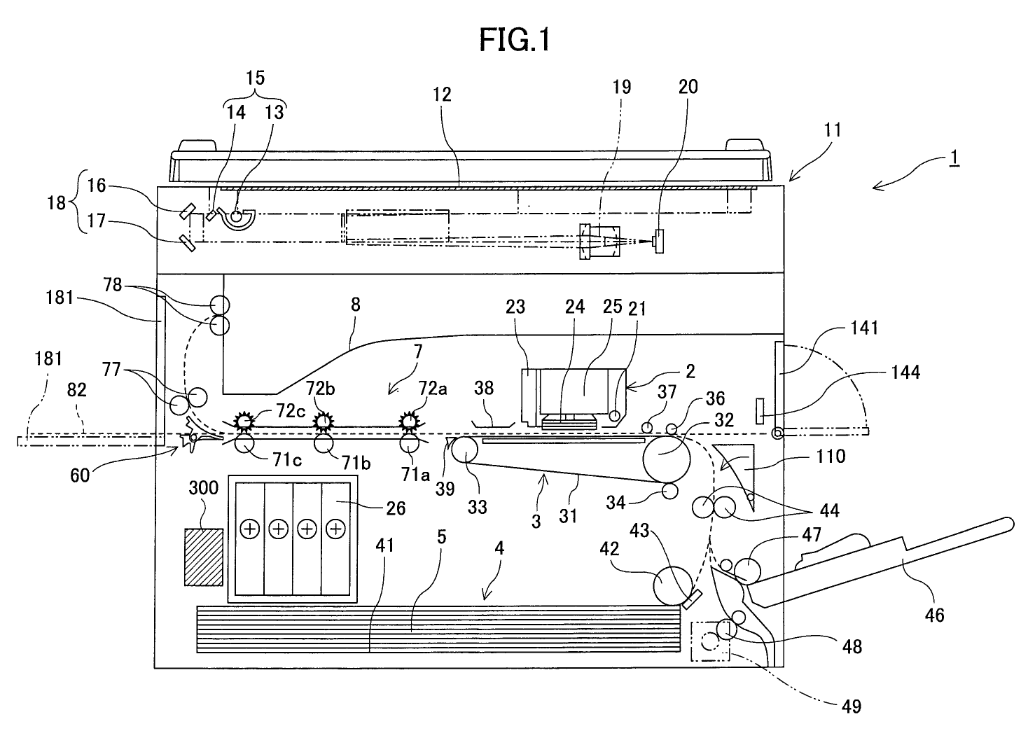

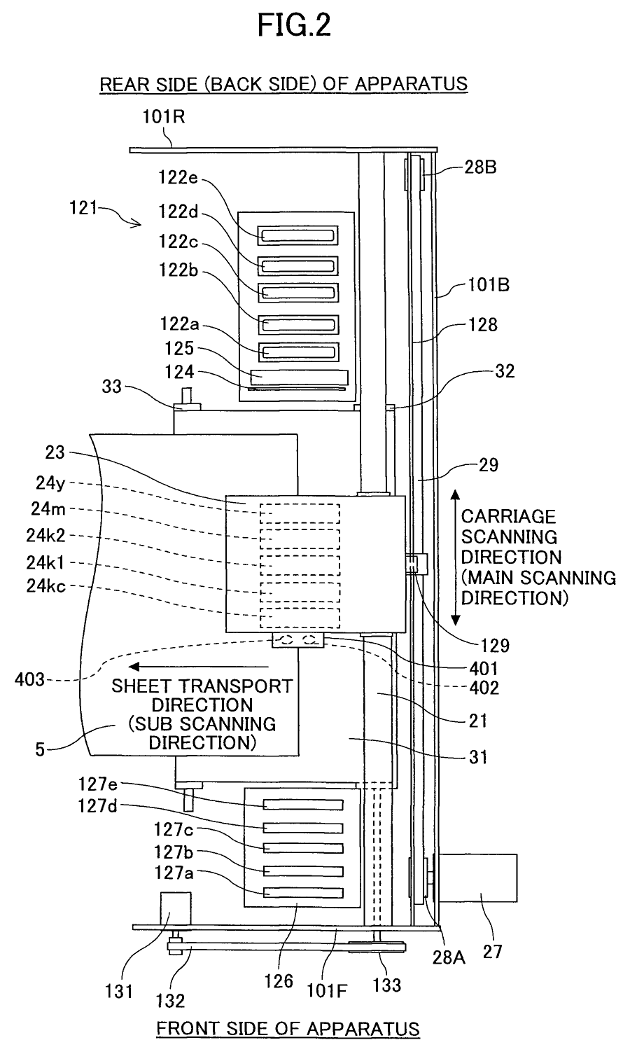

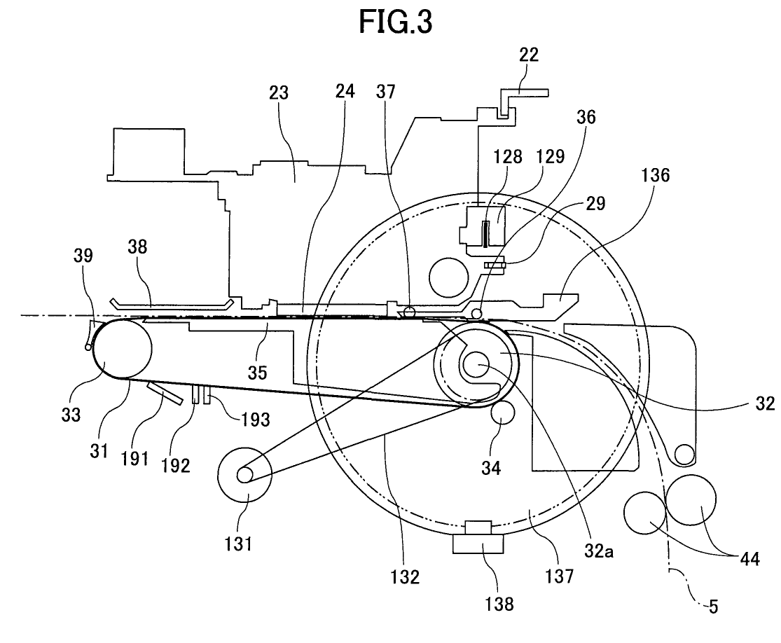

Exemplary embodiments of the present invention are described below with reference to the accompanying drawings. An example of an image forming apparatus of an embodiment of the present invention is described below with reference to FIGS. 1 through 5. FIG. 1 is a schematic configuration diagram illustrating the image forming apparatus. FIG. 2 is a plan view illustrating an image forming unit 2 and a sub scanning transport unit 3 of the image forming apparatus. FIG. 3 is a partly cut-away front view illustrating the image forming unit 2 and the sub scanning transport unit 3.

The image forming apparatus includes, in an apparatus main body 1 (i.e., in a casing), the image forming unit 2 that forms an image on a sheet (recording medium) 5 being transported and the sub scanning transport unit 3 that transports the sheet 5. In the image forming apparatus, sheets 5 are fed one by one from a feed unit 4 including a feed cassette 41 at the bottom of the apparatus main body 1. The sheet 5 is transported by the sub scanning transport unit 3 to the position facing the image forming unit 2, at which an image is formed (recorded) on the sheet 5 by droplets ejected from the image forming unit 2. Then the sheet 5 is discharged by a discharge transport unit 7 onto a discharge tray 8 at the upper side of the apparatus main body 1.

The image forming apparatus further includes an image reading unit (scanner unit) 11 above the discharge tray 8 in the upper side of the apparatus main body 1 for scanning images. The image reading unit serves as an image data (print data) input unit for reading image data, based on which the image forming unit 2 forms an image. The image reading unit 11 scans an image of the original document placed on a contact glass 12 by moving a first scanning optical unit 15, including a light source 13 and a mirror 14, and a second scanning optical unit 18, including mirrors 16 and 17. The scanned image of the original document is read as image signals by an image scanning element 20 disposed behind a lens 19. The read image signals are digitized and processed into print data for printout.

Referring to FIG. 2, in the image forming unit 2 of the image forming apparatus, a carriage 23 is held movably in a main scanning direction by a carriage guide (guide rod) 21, which is a main guide member extending between a front panel 101F and a rear panel 101R, and a guide stay (not shown), which is a sub guide member disposed at the side of a rear stay 101B. The carriage 23 is moved in the main scanning direction by a main scanning motor 27 via a timing belt 29 extending around a drive pulley 28A and a driven pulley 28B.

On the carriage 23 are mounted a total of five recording heads (liquid ejection heads) 24, namely, recording heads 24k1 and 24k2 for ejecting black (K) ink, a recording head 24c for cyan (C) ink, a recording head 24m for magenta (M) ink, and a recording head 24y for yellow (Y) ink (these recording heads 24k1, 24K2, 24c, 24m, and 24y may be referred to as the recording heads 24 when the colors are not referred to). The image forming unit 2 is a shuttle type which reciprocally moves the carriage 23 in the main scanning direction while ejecting droplets from the recording heads 24 to form an image on the sheet 5 being transported in a sheet transport direction (a sub scanning direction) by the sub scanning transport unit 3.

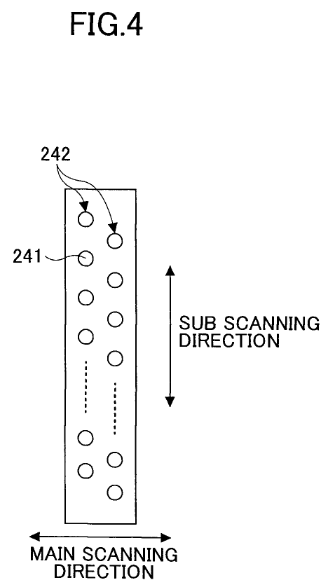

Note that, as shown in FIG. 4, each recording head 24 includes a nozzle array 242 in which plural nozzles 241 for ejecting droplets are arranged. The recording head 24 is mounted on the carriage 23 so that the main scanning direction of the carriage 23 is orthogonal to the nozzle arrangement direction (sheet transport direction, sub scanning direction).

Referring back to FIG. 1, on the carriage 23 are also mounted sub tanks 25 that supply color recording liquids to the corresponding recording heads 24. Ink cartridges 26 storing black (K) ink, cyan (C) ink, magenta (M) ink, and yellow (Y) ink are detachably attached to a cartridge attachment section (not shown) from the front of the apparatus main body 1. The inks (recording liquids) in the ink cartridges 26 are supplied to the corresponding sub tanks 25 via tubes (not shown). The black ink is supplied from the black ink cartridge 26 to the two black sub tanks 25.

The recording head 24 may be a piezo type that includes a pressure generating unit (actuator unit) and is configured to apply pressure to ink in an ink passage (pressure generating chamber) and deform a wall of the ink passage so as to change the volume of the ink passage, thereby ejecting ink droplets; a thermal type configured to heat the ink in an ink passage using a heating element so as to form bubbles, thereby ejecting the ink with pressure of the bubbles; or an electrostatic type that includes a diaphragm on a wall of an ink passage and an electrode opposing the diaphragm and is configured to deform the diaphragm with static electricity between the diaphragm and the electrode so as to change the volume of the ink passage, thereby ejecting ink droplets.

Referring again to FIG. 2, a linear scale 128 having slits is disposed to extend between the front panel 101F and the rear panel 101R in the main scanning direction of the carriage 23. The carriage 23 is provided with an encoder sensor 129 including a transmissive photosensor for detecting the slits of the linear scale 128. The linear scale 128 and the encoder sensor 129 constitute a linear encoder that detects movement and the position (carriage position) of the carriage 23.

A pattern reading sensor 401 (hereinafter referred to simply as a “reading sensor”) as a reading unit (detecting unit) is disposed on a side surface of the carriage 23. The reading sensor 401 is an optical sensor formed of a reflective photosensor including a light emitting unit and a light receiving unit for reading a print pattern according to an embodiment of the present invention. The reading sensor 401 reads a print pattern 400 formed on a transport belt 31 as described below.

A maintenance recovery mechanism (device) 121 for maintaining and restoring the condition of nozzles of the recording heads 24 is provided in a non-printing region at one side in the scanning direction of the carriage 23. The maintenance recovery mechanism 121 includes one suction cap 122a, serving also as a dry-proof cap, and four dry-proof caps 122b-122e for capping nozzle faces of the five recording heads 24. The maintenance recovery mechanism 121 further includes a wiper blade 124 for wiping the nozzle faces of the recording heads 24, and an idle ejection receiver 125 for idle ejection. Another idle ejection receiver 126 for idle ejection is disposed in a non-printing region at the other end in the scanning direction of the carriage 23. The idle ejection receiver 126 includes openings 127a-127e.

Referring also to FIG. 3, the sub scanning transport unit 3 includes a transport roller 32 as a drive roller that changes a transport direction of the sheet 5 fed from the lower side by 90 degrees such that the sheet 5 is transported in a manner facing the image forming unit 2, a driven roller 33 as a tension roller, the endless transport belt 31 extending around the transport roller 32 and the driven roller 33, a charging roller 34 as a charger that charges the surface of the transport belt 31 with a high voltage (alternating current) from a high-voltage power supply, a guide member 35 that guides the transport belt 31 within an area opposing the image forming unit 2, pressure rollers 36 and 37 rotatably supported by a support member 136 and configured to press the sheet 5 against the transport belt 31 at a position opposing the transport roller 32, a guide plate 38 that presses the upper surface of the sheet 5 on which images are formed by the image forming unit 2, and a separation claw 39 that separates the sheet 5 on which images are formed from the transport belt 31.

The transport belt 31 is rotated to transport the sheet 5 in the sheet transport direction (sub scanning direction) when the transport roller 32 is rotated through a timing belt 132 and a timing roller 133 by a sub scanning motor 131 using a DC brushless motor. Although the transport belt 31 has a double layer structure including a front surface (sheet adhesion surface) made of a pure resin material, such as pure ETFE material, with no resistance control, and a back side (middle resistance layer, grounding layer) made of the same material as the front layer but with resistance control by carbon, the transport belt 31 may have a single layer structure or a structure having three or more layers.

Disposed between the driven roller 33 and the charging roller 34 are a cleaning unit (paper powder removing unit) 191 made of a PET film of Mylar (trademark) that is in contact with the transport belt 31 to remove paper powder adhering to the transport belt 31 from the upstream in the moving direction of the transport belt 31, a cleaning brush 192 that is in contact with the transport belt 31, and a discharging brush 193 that discharges the surface of the transport belt 31.

A code wheel 137 of high resolution is attached to a shaft 32a of the transport roller 32. An encoder sensor 138 including a transmissive photosensor for detecting slits (not shown) is formed in the code wheel 137. The code wheel 137 and the encoder sensor 138 form a rotary encoder.

The feed unit 4 includes the feed cassette 41 that is removable from the apparatus main body 1 and capable of storing a large number of sheets 5 in a stack, a feed roller 42 and a friction pad 43 for feeding the sheets 5 one by one, and a pair of registration rollers 44 for registration of the fed sheet 5.

The feed unit 4 includes a manual feed tray 46 capable of storing a large number of sheets 5 in a stack, a manual feed roller 47 that feeds the sheets 5 one by one from the manual feed tray 46, a vertical transport roller 48 that transports the sheet 5 fed from another feed cassette (not shown), which can be optionally attached to the lower side of the apparatus main body 1, or fed from a duplexing unit (not shown). Rollers for feeding the sheet 5 to the sub scanning transport unit 3, such as the feed roller 42, the pair of registration rollers 44, the manual feed roller 47, and the vertical transport roller 48, are driven by a feed motor (drive unit) 49, which is an HB stepping motor, via an electromagnetic clutch (not shown).

The discharge transport unit 7 includes three transport rollers 71a, 71b, and 71c (also referred to as transport rollers 71) that transport the sheet 5 separated by the separation claw 39 of the sub scanning transport unit 3; three spurs 72a, 72b, and 72c (also referred to as spurs 72) facing the transport rollers 71a, 71b, and 71c, respectively; a pair of reverse rollers 77 for reversing the sheet 5; and a pair of reverse discharge rollers 78 for outputting the sheet 5 with its face down onto the discharge tray 8.

As shown in FIG. 1, in the image forming apparatus, a single sheet manual feed tray 141 for manually feeding a single sheet is rotatably attached to one side of the apparatus main body 1. When manually feeding a single sheet, the single sheet manual feed tray 141 is rotated to an open position shown by the two-dotted lines. The sheet 5 that has been manually fed from the single sheet manual feed tray 141 is guided by the upper surface of a guide plate 110 to be inserted straight between the transport roller 32 and the pressure roller 36 of the sub scanning transport unit 3.

A straight discharge tray 181 is rotatably attached to the other side of the apparatus main body 1. The sheet 5 with an image formed is discharged straight ahead, with its face up, onto the straight discharge tray 181. When the straight discharge tray 181 is rotated to an open position shown by the two-dotted lines, the sheet 5 that has been transported by the discharge transport unit 7 can be discharged linearly onto the straight discharge tray 181.

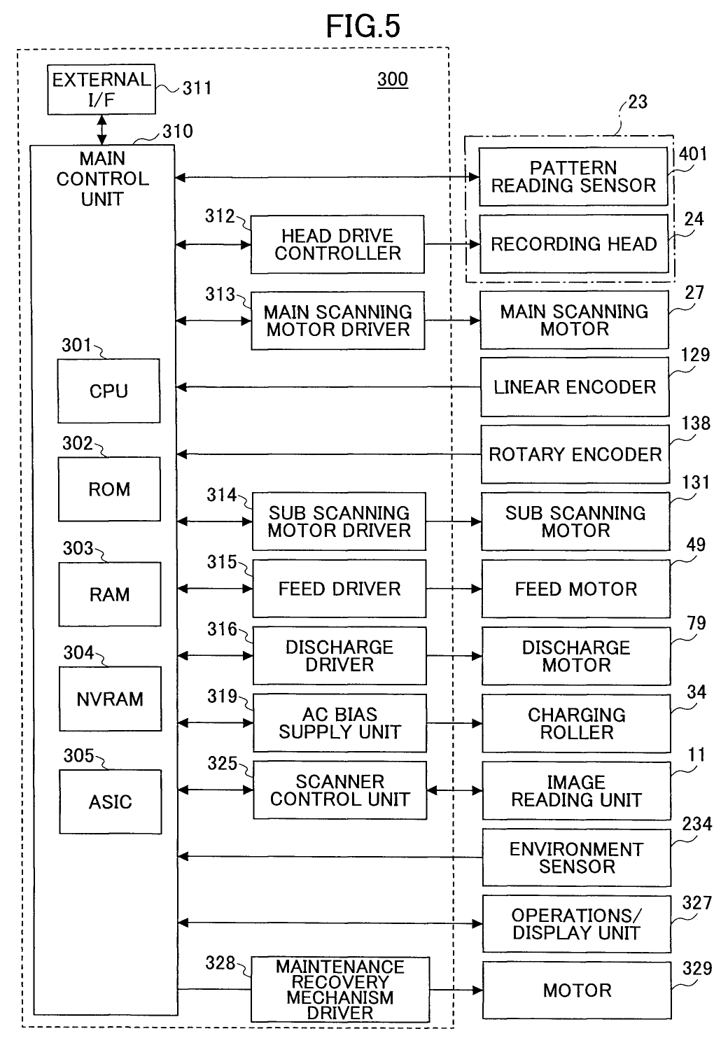

An overview of a control unit 300 of the image forming apparatus is described below with reference to FIG. 5.

The control unit 300 includes a main control unit 310 that controls the entire operation of the image forming apparatus and controls formation of the print pattern 400, position measurement of the print pattern 400, detection of a recording head inclination, and impact position adjustment (correction). The main control unit 310 includes a CPU 301, a ROM 302 that stores programs to be executed by the CPU 301 and other fixed data, a RAM 303 that temporarily stores image data, etc., a nonvolatile memory (NVRAM) 304 that retains data even when power is removed, and an ASIC 305 that processes input/output signals for processing images such as sorting and for controlling the apparatus.

The control unit 300 further includes an external I/F 311 through which signals and data are transmitted to a host device from the main control unit 310 and from the host device to the main control unit 310; a head drive controller 312 including a head driver (actually attached to the side of the recording heads 24) that controls and drives the recording heads 24 and includes an ASIC for head data generation sequence conversion; a main scanning motor driver 313 that drives the main scanning motor 27 for moving the carriage 23; a sub scanning motor driver 314 that drives the sub scanning motor 131; a feed driver 315 that drives the feed motor 49; a discharge driver 316 that drives a discharge motor 79 for driving the rollers of the discharge transport unit 7; an AC bias supply unit 319 that supplies an AC bias to the charging roller 34; a maintenance recovery mechanism driver 328 that drives a maintenance recovery motor 329 for driving the maintenance recovery mechanism 121; a duplexing unit driver (not shown) that drives a duplexing unit when the duplexing unit is attached; a solenoid driver (not shown) that drives various solenoids (SOLs); a clutch driver (not shown) that drives electromagnetic clutches (not shown); and a scanner control unit 325 that controls the image reading unit 11.

The main control unit 310 receives various detection signals, such as signals indicating the temperature and humidity (environmental conditions) around the transport belt 31 from an environment sensor 234. The main control unit 310 receives detection signals from various other sensors (not shown). The main control unit 310 receives instructions entered through various keys, such as numeric keys and a print start key, disposed on the apparatus main body 1. The main control unit 310 also receives instructions entered through an operations/display unit 327 and outputs information to be displayed to the operations/display unit 327.

The main control unit 310 also receives an output signal from the photosensor (encoder sensor) 129 of the linear encoder for detecting the position of the carriage 23, and controls the main scanning motor 27 through the main scanning motor driver 313 based on the output signal so as to reciprocate the carriage 23 in the main scanning direction. The main control unit 310 also receives an output signal (pulse) from the photosensor (encoder sensor) 138 of the rotary encoder for detecting the amount of the rotation of the transport belt 31, and controls the sub scanning motor 131 through the sub scanning motor driver 314 based on the output signal so as to rotate the transport belt 31 via the transport roller 32.

The main control unit 310 controls an operation of forming the print pattern 400 on the transport belt 31 and performs light emission control for causing the light emitting unit of the reading sensor 401 mounted on the carriage 23 to emit a light onto the print pattern 400. The main control unit 310 also controls operations of reading the print pattern 400 by receiving an output signal of the light receiving unit, measuring the print positions of plural points of the print pattern 400, which are located at different positions in the sub scanning direction (nozzle arrangement direction), in the main scanning direction (the direction orthogonal to the nozzle arrangement direction) based on the read result, detecting an inclination of the recording head 24 based on the measurement results of the print positions of the plural points, and correcting the droplet ejection timing of the recording head 24 to eliminate an impact position shift based on the inclination detection result. The control operations by the main control unit 310 are described below in greater detail.

The main control unit 310 also controls, when performing a maintenance recovery operation for the recording heads 24, the motor 329 for driving the maintenance recovery mechanism 121 using the maintenance recovery mechanism driver 328, thereby moving up and down the caps 122 and the wiper blade 124.

An image forming operation by the image forming apparatus having the above-described configuration is briefly described below. The amount of rotation of the transport roller 32, which drives the transport belt 31, is detected. The sub scanning motor 131 is controlled according to the detected amount of rotation. The AC bias supply unit 319 applies a bipolar rectangular-wave high voltage as an alternating voltage to the charging roller 34. Thus, the transport belt 31 is alternately positively and negatively charged at predetermined widths in the transport direction of the transport belt 31, thereby forming a non-uniform electric field on the transport belt 31.

When the sheet 5 sent from the feed unit 4 passes through between the transport roller 32 and the pressure roller 36 onto the transport belt 31 on which the non-uniform electric field is generated by positive and negative charges, the sheet 5 is instantaneously polarized along a direction of the electric field and is adhered onto the transport belt 31 due to an electrostatic attraction force. Thus, the sheet 5 is transported along with the movement of the transport belt 31.

The sheet 5 is intermittently transported by the transport belt 31. The recording heads 24 eject droplets of recording liquids onto the stationary sheet 5 to record (print) images while moving the carriage 23 in the main scanning direction. The separation claw 39 separates the leading edge of the printed sheet 5 from the transport belt 31 to transport the sheet 5 to the discharge transport unit 7. The discharge transport unit 7 discharges the sheet 5 onto the discharge tray 8.

The carriage 23 is moved to the side of the maintenance recovery mechanism 121 while standing by for a print (recording) operation. The nozzle faces of the recording heads 24 are capped by the caps 122 for keeping the nozzles wet, thereby preventing poor ejection due to ink dryout. A recovery operation is performed for ejecting thickened recording liquid and bubbles by suctioning the recording liquid from the nozzles of each recording head 24 capped by the suction cap 122a. The wiper blade 124 wipes the nozzle face of the recording head 24 to remove the ink adhering to the nozzle face as a result of the recovery operation. Further, before starting a recording operation or during a recording operation, idle ejection is performed not for forming images but for ejecting ink to the idle ejection receiver 125. The idle ejection enables the recording heads 24 to maintain stable ejection performance.

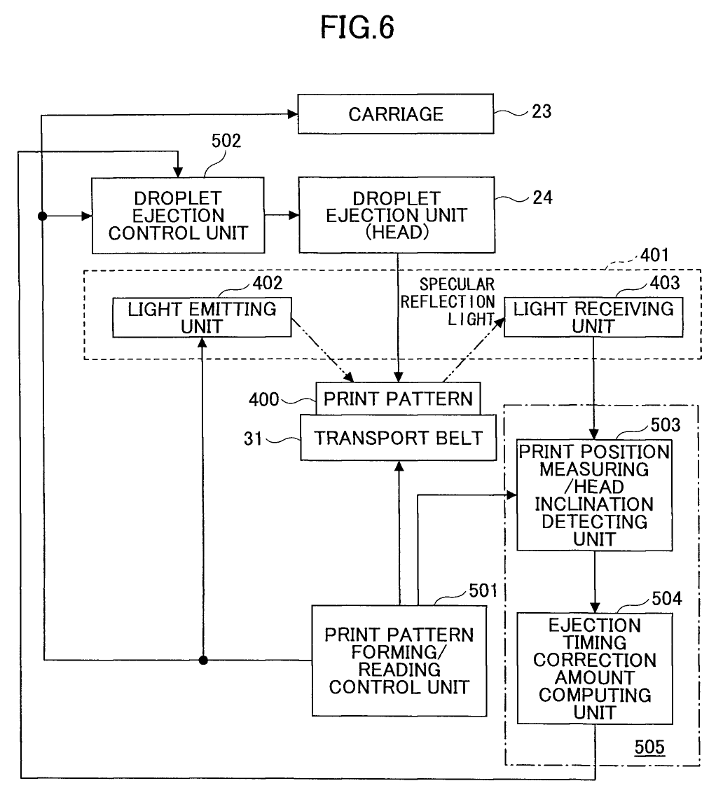

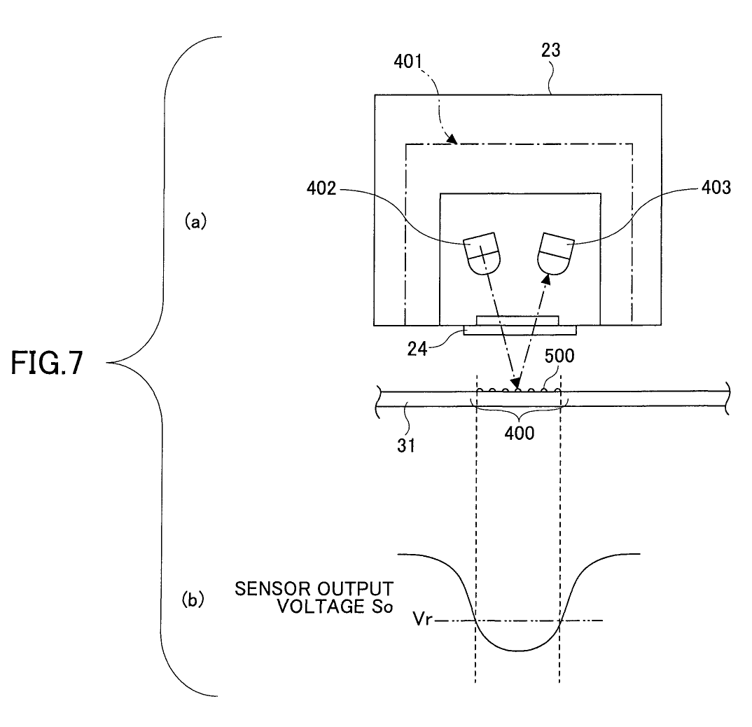

Next, components of the image forming apparatus for head inclination detection and droplet impact position correction are described with reference to the functional block diagram of FIG. 6 and the diagram of FIG. 7.

The reading sensor 401 as a reading unit for detecting the print pattern 400 formed on the transport belt 31 is disposed on the carriage 23. The reading sensor 401 is a package in which a light emitting element 402 as a light emitting unit for emitting light onto the print pattern 400 on the transport belt 31 and a light receiving element 403 as a light receiving unit for receiving specular reflection light from the print pattern 400 are aligned in the direction orthogonal to the main scanning direction and are held by a holder (not shown).

As mentioned above, the light emitting element 402 and the light receiving element 403 of the pattern reading sensor 401 are aligned in the direction orthogonal to the main scanning direction of the carriage 23 as shown in FIG. 2. This configuration can prevent fluctuation of the moving speed of the carriage 23 from adversely affecting the detection results. A relatively simple and inexpensive light source, such as an LED, that emits infrared rays or visible light may be used as the light emitting element 402. An inexpensive lens is used in place of using a high accuracy lens, and hence the spot diameter of the light source (detection range, detection area) is of the order of millimeters.

A print pattern forming/reading control unit 501 causes the carriage 23 to move over the transport belt 31 in the main scanning direction and stop at a predetermined position in the main scanning direction and causes the recording heads 24 as droplet ejection units to eject droplets from the nozzle arrays 242 using a liquid droplet ejection control unit 502, thereby forming the linear print pattern 400 of plural separate droplets 500.

The print pattern forming/reading control unit 501 also performs a reading control operation of moving the carriage 23 and reading an edge end of the transport belt 31 and the print pattern 400 formed on the transport belt 31 using the reading sensor 401. With this reading control operation, the print pattern forming/reading control unit 501 drives the light emitting element 402 of the reading sensor 401 to emit light onto the transport belt 31 from the outside of an edge end of the transport belt 31 and causes the carriage 23 to move in the main scanning direction and scan at least to a predetermined position beyond the edge end in the main scanning direction.

Thus, the light emitted from the light emitting element 402 is reflected and incident on the light receiving element 403, and the light receiving element 403 outputs a detection signal corresponding to the amount of the received light to a print position measuring/head inclination detecting unit 503 of an impact position correcting unit 505.

Here, the reading sensor 401 scans to read two points one at the upstream end and one at the downstream end of the print pattern 400 in the sheet transport direction (nozzle arrangement direction), and the print position measuring/head inclination detecting unit 503 measures the print positions of the two points at the opposing ends of the print pattern 400 in the main scanning direction from the position of the carriage 23 in the main scanning direction based on the read result of the reading sensor 401 to detect the inclination amount of the recording head 24 in the main scanning direction (e.g., the shift amount of an end in the main scanning direction with reference to the other end).

The inclination of the recording head 24 detected by the print position measuring/head inclination detecting unit 503 is supplied to an ejection timing correction amount computing unit 504. The ejection timing correction amount computing unit 504 calculates a correction amount of the ejection timing to be used when the droplet ejection control unit 502 drives the recording heads 24 so as to eliminate a droplet impact position shift based on the inclination of the recording head. The calculated ejection timing correction amount is set for the droplet ejection control unit 502. When driving the recording head 24, the droplet ejection control unit 502 uses an ejection timing which has been corrected based on the correction amount, and hence a shift of the droplet impact position due to the inclination of the recording head 24 is reduced.

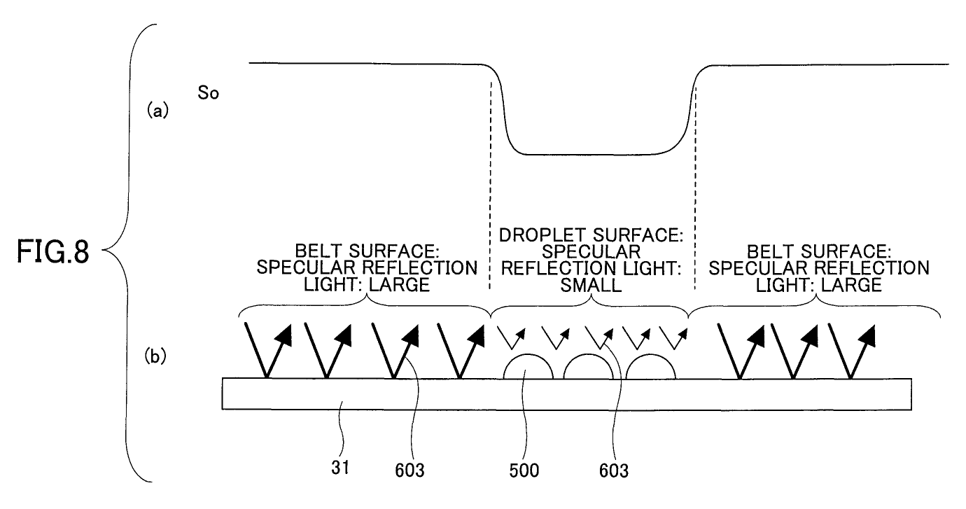

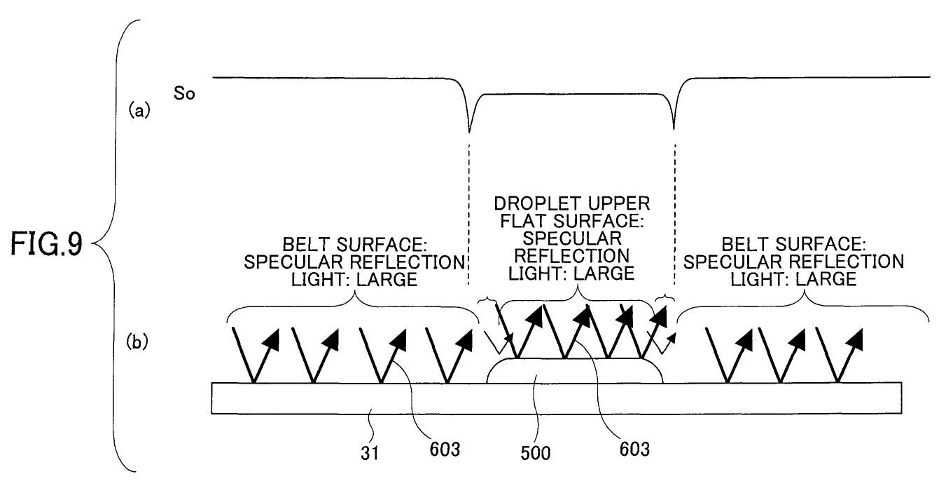

Formation of the print pattern 400 and the detection principle of the print pattern 400 are described below with reference to FIGS. 8 and 9.

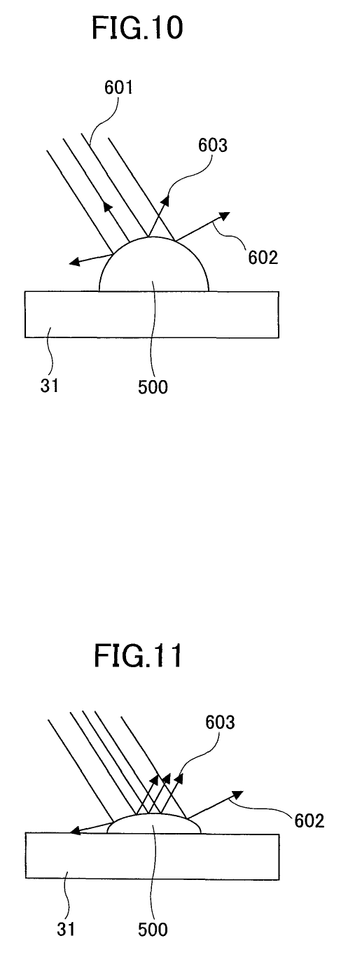

As shown in FIG. 8-(b), the print pattern 400 of plural separate ink droplets 500 is formed on the transport belt 31 (the ink droplets 500 ejected on the transport belt 31 have a hemispherical shape). Considering the single ink droplet 500 further, as shown in FIG. 10, when light is emitted from the light emitting element 402, since the ink droplet 500 has a glossy round surface, most of the incident light is detected as diffused reflection light 602 and a small part of the incident light is detected as specular reflection light 603.

In this embodiment, the transport belt 31 has a glossy surface (belt surface) which tends to return specular reflection light when light is emitted from the light emitting element 402. Therefore, in the case where scanning is performed by emitting light from the light emitting element 402 of the reading sensor 401 onto the transport belt 31 and the print pattern 400 of plural separate ink droplets 500 is formed on the transport belt 31, the light is diffused by the glossy surface of the ink droplets 500 having a hemispherical shape. Accordingly, the amount of the specular reflection light 603 is reduced on the print pattern 400, so that the output (a sensor output voltage So) of the light receiving element 403 for receiving the specular reflection light 603 is relatively reduced.

Therefore, it is possible to detect the position of the print pattern 400 formed on the transport belt 31 based on the sensor output voltage So of the reading sensor 401.

On the other hand, as shown in FIG. 9-(b), in the case where ink droplets come into contact with and are connected to adjacent ink droplets on the transport belt 31 to form a “connected” ink droplet 500, the connected ink droplet 500 has a flat upper surface, and hence the amount of the specular reflection light 603 is increased. Accordingly, as shown n FIG. 9-(a) the sensor output voltage So on the surface of the ink droplet 500 is substantially the same as the sensor output voltage So on the transport belt 31, which makes it difficult to detect the position of the ink droplet 500. Although scattered reflection light is generated at the edge of the connected ink droplet 500 formed of connected ink droplets, the area which generates the scattered reflection light is very limited, and therefore it is difficult to detect the print pattern 400. To detect the print pattern 400 of the connected droplet 500, the detection area of the light receiving element 403 needs to be reduced, and hence the light receiving element 403 may respond to noise elements such as a small scratch and dust on the surface of the transport belt 31, which results in reduced detection accuracy and reduced reliability of the detection result.

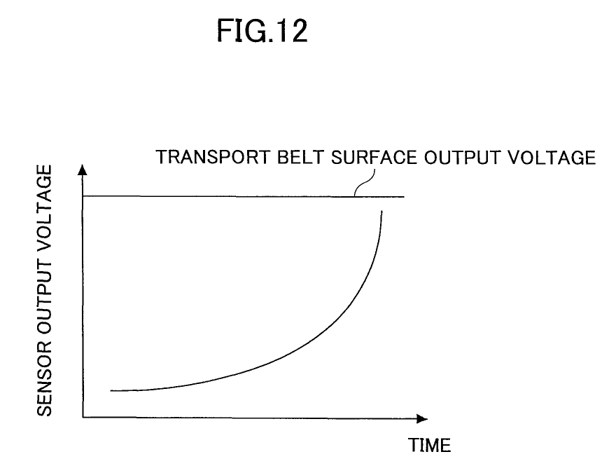

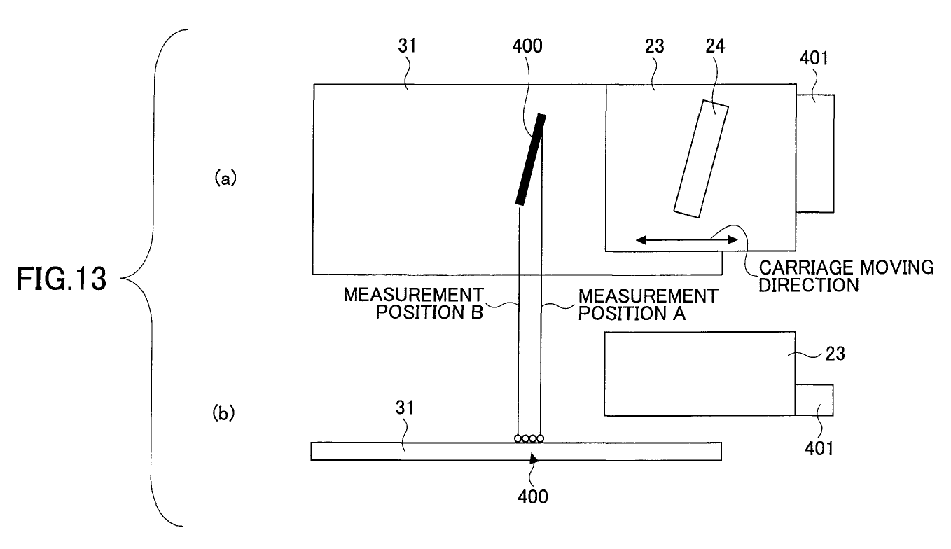

Note that, as shown in FIG. 11, the ink droplets 500 dry and lose the surface gloss over time, and gradually change their shapes from hemispherical to flat. As a result, the area which generates the specular reflection light 603 and its ratio are relatively increased with respect to the area which generates the diffused reflection light 602, so that it becomes impossible to distinguish the reflection light from the ink droplets 500 from the reflection light from the transport belt 31. Accordingly, in the case where the specular reflection light 603 is received by the light receiving element 403, as shown in FIG. 12, the sensor output voltage So becomes closer to the output voltage generated by reception of the reflection light from the transport belt 31 as time progresses, and hence the detection accuracy is gradually reduced as time progresses. Therefore, once the print pattern 400 is formed, it is preferable to detect the print pattern 400 before the ink droplets 500 become flat.

As described above, the print pattern 400 is detected by identifying a portion of a reduced amount of specular reflection light in the output of the light receiving unit that receives specular reflection light from ink droplets. Therefore, it is possible to detect the print pattern 400 with high accuracy. Preferably, the print pattern 400 is formed of plural separate droplets within the detection area of the reading sensor 401. More preferably, the ink droplets are close to one another (i.e., the area between the droplets is small with respect to the area where the droplets are deposited in the detection area).

Here, in view of the properties specific to the droplets, a print pattern of plural separate droplets is formed on a water repellent transport belt. Therefore, it is possible to detect the print pattern with high accuracy based on variations in the amount of the specular reflection light received from the print pattern and hence it is possible to detect an inclination of a recording head with high accuracy.

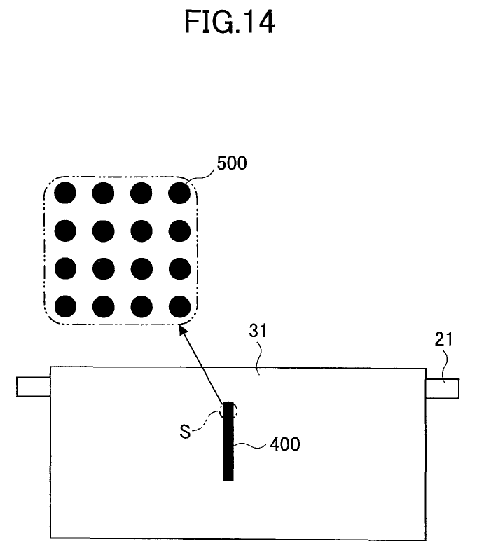

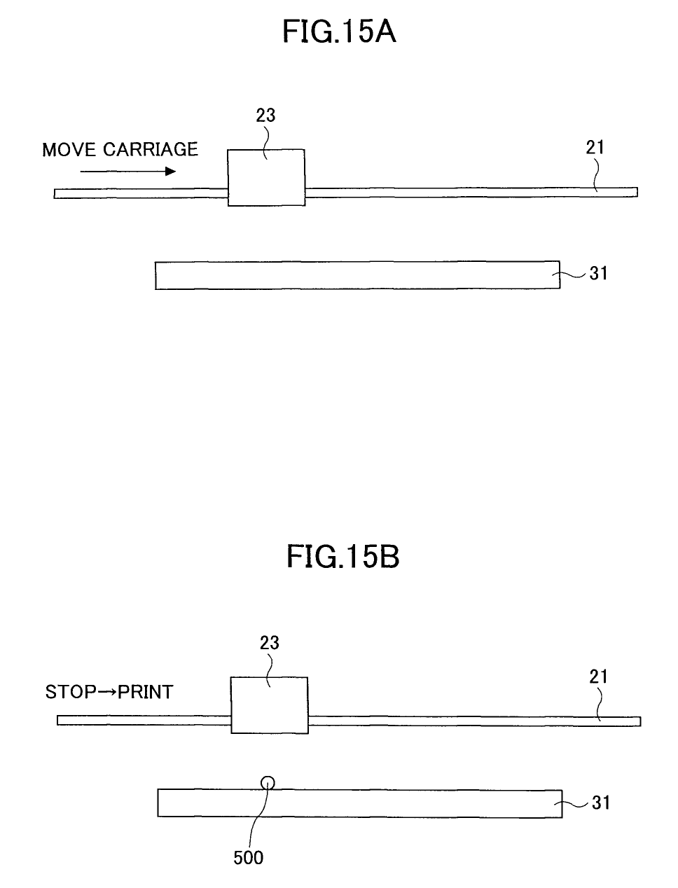

Next, detection of a recording head inclination is described with reference to FIGS. 13 through 17 according to this embodiment of the present invention. First, as shown in FIG. 13, the carriage 23 is moved to a predetermined position on the transport belt 31. While stopping the carriage 23 and the transport belt 31 are stopped, droplets are ejected onto the transport belt 31 using at least nozzles 241 at the opposing ends of the nozzle array 242 of the recording head 24 (in this example, using all the nozzles 241) to form a print pattern 400. As illustrated in FIG. 14 in which a portion S is shown enlarged, the print pattern 400 is formed of plural substantially separate droplets 500 that are arranged regularly.

Then, the carriage 23 is moved so that the reading sensor 401 measures the position (a measurement position A) of an end of the print pattern 400 in the main scanning direction and the position (a measurement position B) of the other end of the print pattern 400 in the main scanning direction. Based on the deviation between and the direction of the measurement position A (print position) and the measurement position B (print position), an inclination of the nozzle array 242 of the recording head 24 in the main scanning direction can be detected. Although the inclination of the recording head 24 is detected based on the print positions of two points in this example, the print positions of three or more points may be measured to detect an inclination.

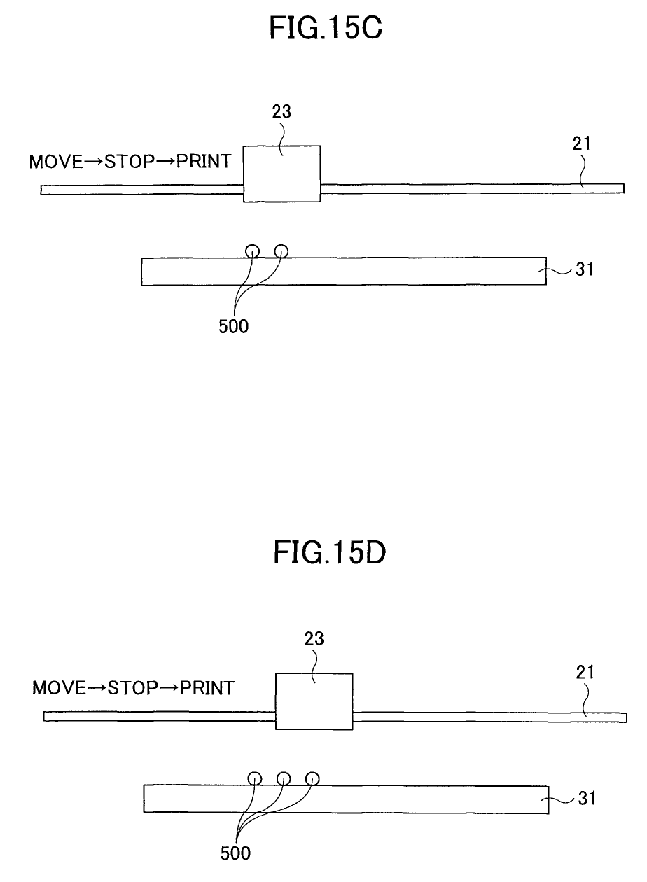

More specifically, as shown in FIG. 15A, the carriage 23 is moved to a predetermined position. Then, as shown in FIG. 15B, while the carriage 23 is stopped, the recording head 24 is driven to eject droplets 500 onto the transport belt 31. Then, as shown in FIG. 15C, the carriage 23 is moved a predetermined distance and stopped, and the recording head 24 is driven again to eject droplets 500 onto the transport belt 31. Then, as shown in FIG. 15D, the same process is repeated, i.e., the carriage 23 is moved a predetermined distance and stopped and the recording head 24 is driven again to eject droplets 500 onto the transport belt 31. Thus, the print pattern 400 of plural separate droplets 500 is formed.

Forming the print pattern 400 while the carriage 23 is stopped as described above can cancel the amount of print shift due to the movement of the carriage 23, which makes it possible to print the print pattern 400 with high accuracy. Here, forming the print pattern 400 by repeating the process of moving the carriage 23, stopping the carriage 23, and performing printing makes the print pattern 400 easily detectable with higher accuracy.

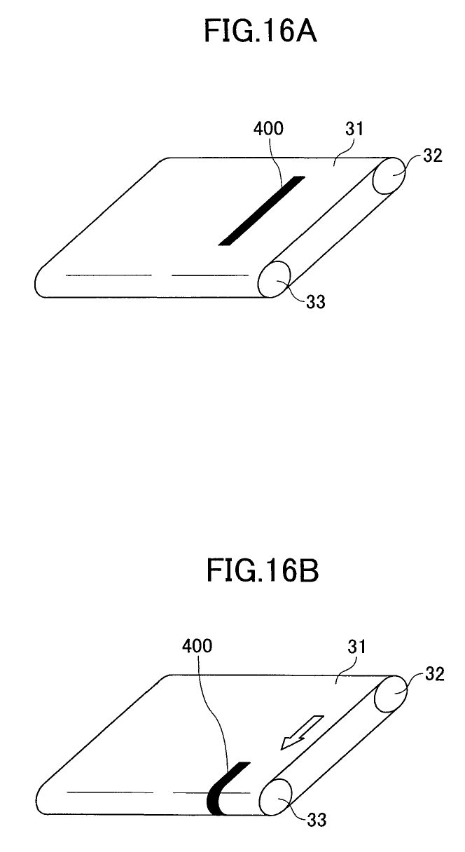

For measuring the print positions by reading the print pattern 400, as shown in FIG. 16A, the carriage 23 is moved so that the reading sensor 401 detects the print position of an end of the print pattern 400 to measure its position in the main scanning direction. Then, as shown in FIG. 16B, the transport belt 31 is moved until the other end of the print pattern 400 is moved to a position that can be scanned by the reading sensor 401 and, after that, the carriage 23 is moved so that the reading sensor 401 detects the print position of the other end of the print pattern 400 to measure its position in the main scanning direction.

In this way, when reading and measuring the print position of the print pattern 400, which is formed using at least the nozzles 241 at the opposing ends of the nozzle array 242 of the recording head 24, the transport belt 31 is moved a distance corresponding to the head length (the length of the nozzle array 242). This makes it possible to measure the print positions of two points of the print pattern 400 using the single reading sensor 401. The transport belt 31 may be movable in both directions in the sheet transport direction, and the moving direction of the transport belt 31 may be determined depending on the attachment position of the reading sensor 401.

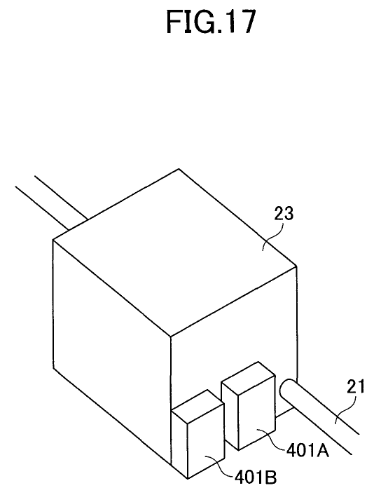

As shown in FIG. 17, two reading sensors 401A and 401B may be attached at two different positions in the sheet transport direction on the carriage 23 such that the print positions of the opposing ends of the print pattern 400 can be read and measured by one scanning operation of the carriage 23.

According to this embodiment, while a carriage is stopped, a print pattern is formed by ejecting droplets from at least nozzles at the opposing ends of an nozzle array of a recording head. Based on the read results of a reading unit which reads the print pattern on a transport belt, the print positions of plural points of the print pattern, which are located at different positions in the nozzle arrangement direction, in the direction orthogonal to the nozzle arrangement direction are measured. Based on the measurement results of the print positions, an inclination of the recording head is detected. Thus, it is possible to accurately detect an inclination of the recording head.

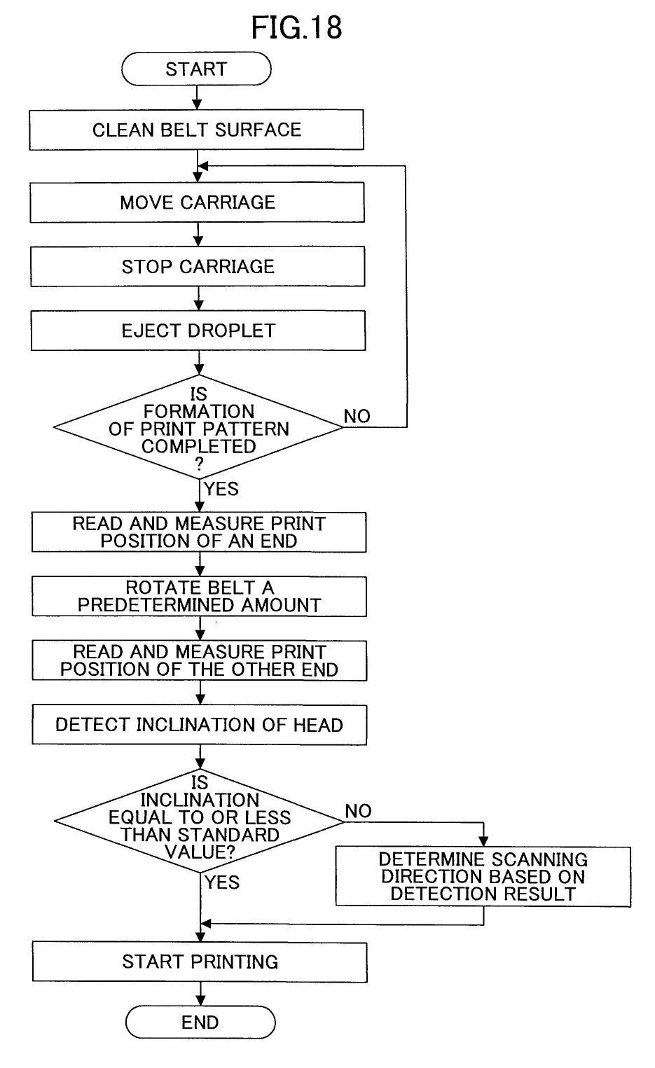

Next, a first example of a process for head inclination detection by the main control unit 310 is described with reference to the flowchart of FIG. 18.

First, after cleaning the belt surface of the transport belt 31, the carriage 23 is moved to and stopped at the predetermined position as mentioned above. Then, droplets are ejected from the nozzles 241 of the nozzle array 242 of the recording head 24, and it is determined whether formation of the print pattern 400 is completed. The process of moving the carriage 23 a predetermined distance, stopping the carriage 23, and ejecting droplets is repeated until formation of the print pattern 400 is completed. In this way, the print pattern 400 is formed on the transport belt 31.

After that, the carriage 23 is moved so that the reading sensor 401 reads an end of the print pattern 400 to measure the print position. Then, the transport belt 31 is moved a predetermined distance and stopped. The carriage 23 is moved again so that the reading sensor 401 reads the other end of the print pattern 400. An inclination of the recording head 24 is detected based on the measurement results of the print positions.

Then, if the inclination of the recording head 24 is equal to or less than a predetermined standard value, the process proceeds directly to a print start operation. On the other hand, if the inclination is greater than the predetermined standard value, the inclination of the recording head 24 is determined to be great. Therefore, the process proceeds to a print start operation after setting the print direction of image formation (the scanning direction of the carriage 23) to one direction.

This prevents an impact position shift due to a head inclination which may occur when printing is performed in two directions, and makes it possible to perform printing with the minimum shift amount.

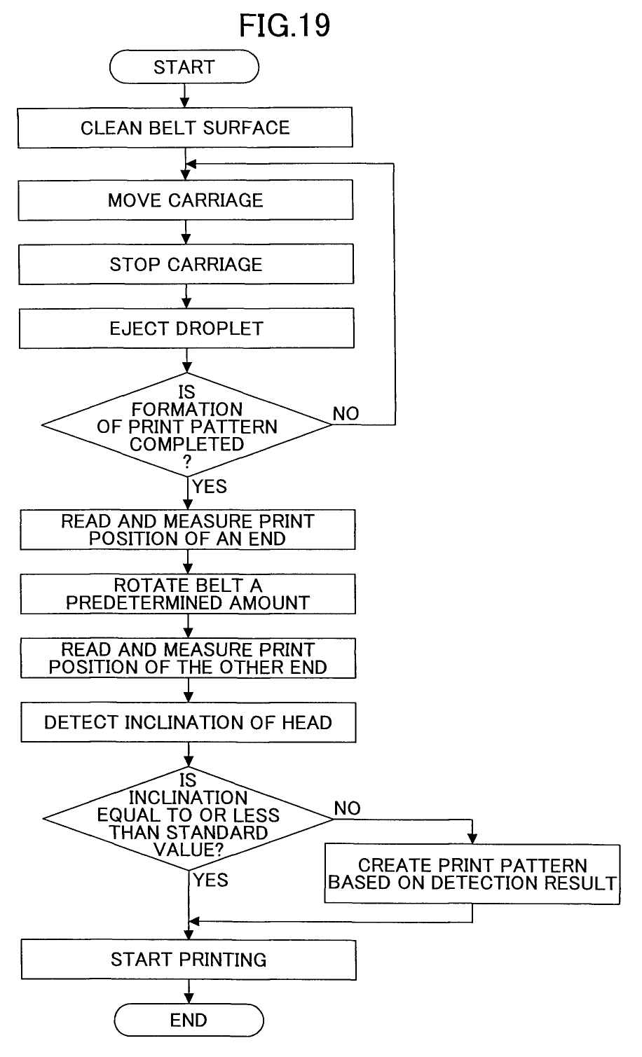

Next, a second example of a process for head inclination detection by the main control unit 310 is described with reference to the flowchart of FIG. 19.

In this example, if the inclination is greater than the predetermined standard value in the first example, the inclination of the recording head 24 is determined to be great. Therefore, printing is performed after changing the print pattern 400 so that the head inclination is corrected upon performing image formation.

In this way, since the print pattern 400 is changed based on the head position information (inclination), even if the head position is shifted, it is possible to print an image as in the case where the head inclination is equal to or less than the standard value.

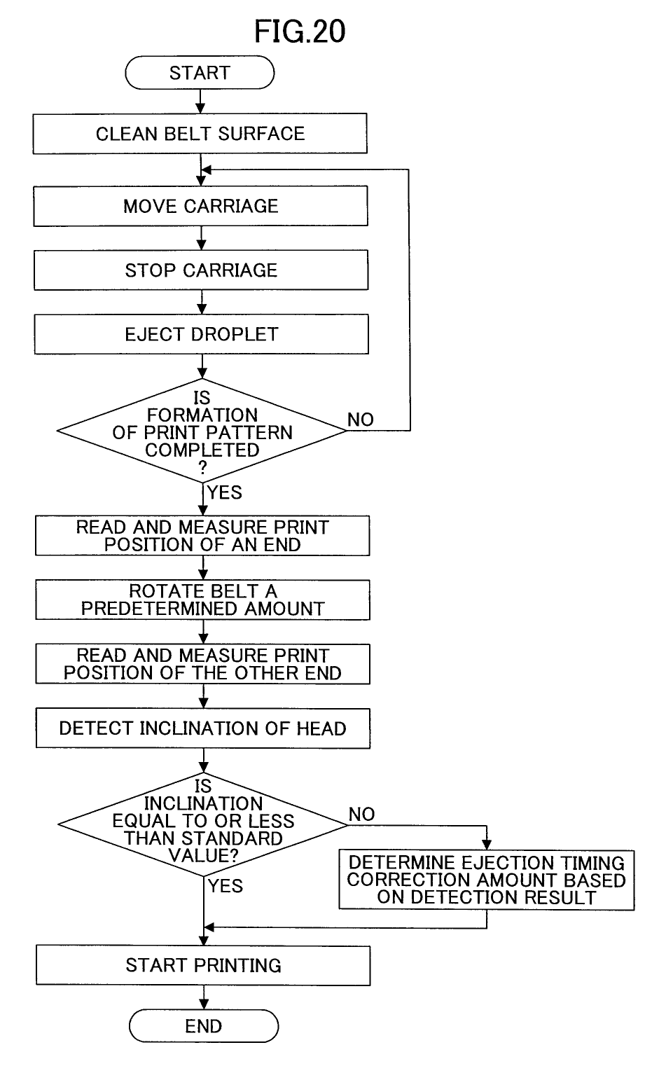

Next, a third example of a process for head inclination detection by the main control unit 310 is described with reference to the flowchart of FIG. 20.

In this example, if the inclination is greater than the predetermined standard value in the first example, the correction amount for varying, among the nozzles 241, the timing of ejecting droplets from the recording head 24 is determined and printing is performed with the corrected ejection timing.

Thus, the impact position shift is corrected, a reduction in the image quality due to the inclination of the recording head 24 is prevented.

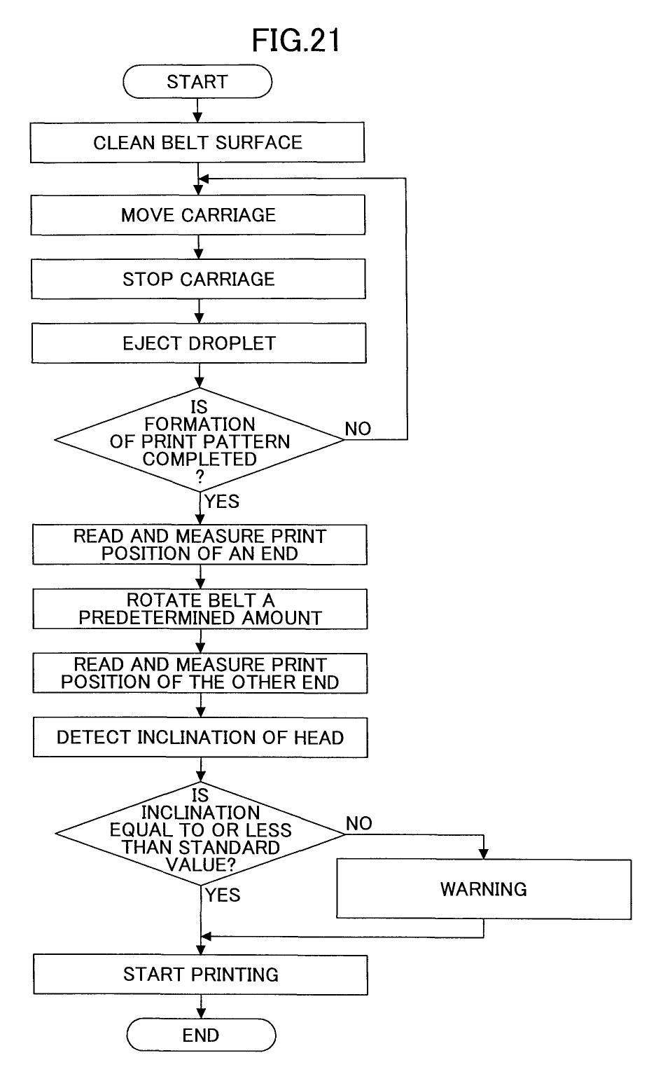

Next, a fourth example of a process for head inclination detection by the main control unit 310 is described with reference to the flowchart of FIG. 21.

In this example, if the inclination is greater than the predetermined standard value in the first example, a warning indicating that the inclination is greater than the predetermined standard value is output in the form of a display, sound, light, vibration or the like.

Then, users can quickly request the service staff for a recovery service.

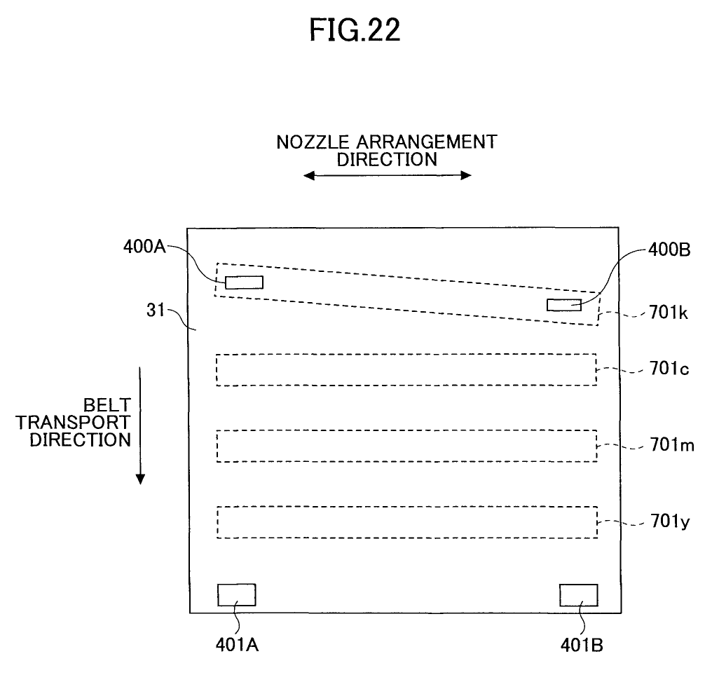

Next, another embodiment of the present invention is described with reference to FIG. 22.

This embodiment is applied to a line type image forming apparatus that includes line type recording heads 701k, 701c, and 701m, each having nozzles for ejecting droplets that are arranged across the sheet width. Print patterns 400A and 400B are formed on the transport belt 31 using the nozzles at the opposing ends of the line type recording head 701. Note that print patterns may be formed using all the nozzles of the line type recording head 701.

Then, the transport belt 31 is moved so that the reading sensors 401A and 401B read the print patterns 400A and 400B on the transport belt 31 to measure the print positions of two (or more) points, thereby detecting an inclination of the recording head 701 in the direction orthogonal to the nozzle arrangement direction.

According to this embodiment, a print pattern is formed by ejecting droplets from at least nozzles at the opposing ends of a nozzle array of a line type recording head. Based on the read results of a reading unit which reads the print pattern on a transport belt, the print positions of plural points of the print pattern, which are located at different positions in the nozzle arrangement direction, in the direction orthogonal to the nozzle arrangement direction are measured. Based on the measurement results of the print positions, an inclination of the recording head is detected. Thus, it is possible to accurately detect an inclination of the line type recording head and prevent a reduction in the image quality by, for example, correcting an impact position shift.

Although detection of an inclination of a single recording head is described in the above embodiments, in the case where there are plural recording heads as in the above embodiments, an inclination of each recording head is detected in the same manner.

The present invention is not limited to the specifically disclosed embodiments, and variations and modifications may be made without departing from the scope of the present invention.

The present application is based on Japanese Priority Application No. 2008-016099 filed on Jan. 28, 2008, with the Japanese Patent Office, the entire contents of which are hereby incorporated herein by reference.

What is claimed is:

1. An image forming apparatus, comprising:
a carriage on which a recording head is mounted that has a nozzle array where plural nozzles for ejecting droplets are arranged, the carriage being configured to be moved in a direction orthogonal to a nozzle arrangement direction;
a transport belt facing the recording head and configured to transport a sheet;
a print pattern forming unit configured to form a print pattern on the transport belt by causing at least the nozzles at opposing ends of the nozzle array of the recording head to eject the droplets onto the transport belt while stopping the carriage;
a reading unit configured to read the print pattern formed on the transport belt;
a measuring unit configured to measure print positions of plural points of the print pattern, which are located at different positions in the nozzle arrangement direction, in a direction orthogonal to the nozzle arrangement direction based on a read result of the reading unit; and
a detecting unit configured to detect an inclination of the recording head based on a measurement result of the print positions.

2. The image forming apparatus as claimed in claim 1, wherein the transport belt is moved a distance corresponding to a length of the nozzle array of the recording head such that the measuring unit measures the print positions of the plural points of the print pattern, which are located at the different positions in the nozzle arrangement direction, in the direction orthogonal to the nozzle arrangement direction.

3. The image forming apparatus as claimed in claim 1, wherein plural of the reading units are provided that are configured to read the print pattern at plural points in the nozzle arrangement direction.

4. The image forming apparatus as claimed in claim 1, wherein the print pattern is formed by repeating a process of moving the carriage, stopping the carriage, ejecting droplets, and moving the transport belt.

5. The image forming apparatus as claimed in claim 1,
wherein the droplets forming the print pattern are spaced apart from each other; and
wherein the reading unit includes a light emitting unit that emits light onto the print pattern and a light receiving unit that receives specular reflection light from the print pattern.

6. The image forming apparatus as claimed in claim 1, wherein if the inclination of the recording head is equal to or greater than a predetermined value, image formation is performed in a single print direction.

7. The image forming apparatus as claimed in claim 1, wherein if the inclination of the recording head is equal to or greater than a predetermined value, image formation is performed after the print pattern is changed.

8. The image forming apparatus as claimed in claim 1, wherein a droplet ejection timing during image formation is corrected based on the inclination of the recording head.

9. The image forming apparatus as claimed in claim 1, further comprising:
a warning output unit configured to output a warning if the inclination of the recording head is greater than a predetermined value.

10. An image forming apparatus, comprising:
a line type recording head having a nozzle array where plural nozzles for ejecting droplets are arranged across a sheet width;
a transport belt facing the recording head and configured to transport a sheet;
a print pattern forming unit configured to form a print pattern by causing at least the nozzles at opposing ends of the nozzle array of the recording head to eject the droplets onto the transport belt;
a reading unit configured to read the print pattern formed on the transport belt;
a measuring unit configured to measure print positions of plural points of the print pattern, which are located at different positions in the nozzle arrangement direction, in a direction orthogonal to the nozzle arrangement direction based on a read result of the reading unit; and
a detecting unit configured to detect an inclination of the recording head based on a measurement result of the print positions.
